(19) United States
(12) Patent Application Publication
(10) Pub. No.: US 2012/0327956 A1
(43) Pub. Date: Dec. 27, 2012

(54) FLOW COMPRESSION ACROSS MULTIPLE PACKET FLOWS

(75) Inventor: Gauthaman Vasudevan, Old Bridge, NJ (US)

(73) Assignee: Altior Inc.

(21) Appl. No.: 13/480,841

(22) Filed: May 25, 2012

Related U.S. Application Data
(60) Provisional application No. 61/596,349, filed on Feb. 8, 2012.
(60) Provisional application No. 61/500,910, filed on Jun. 24, 2011.

(51) Int. Cl. H04L 29/00

(52) U.S. Cl. 370/477

(57) ABSTRACT

In described embodiments, processing of multiple data streams, such as packet streams or flows, associated with data streaming is improved by grouping similar types of traffic, and generating signatures for each of the flows. For a given input flow, its signature is compared against other flow signatures and a best match is determined. Given the context information for the best match, the present input flow can then be compressed. Processing, such as encoding and compression, for the data transformation examines currently arriving data and then processes the data based on the context data and previously known context information for other data streams from history stored in memory.

### CROSS-REFERENCE TO RELATED APPLICATIONS

This application claims the benefit of the filing date of U.S. provisional application No. 61/596349, filed on Feb. 8, 2012, the teachings of which are incorporated herein by reference. This application also claims the benefit of the filing date of U.S. provisional application No. 61/500,910, filed on Jun. 24, 2011, the teachings of which are incorporated herein by reference.

### BACKGROUND OF THE INVENTION

1. Field of the Invention

The present invention relates to compression of data across multiple packet flows, files and non-standard/non-traditional boundaries

2. Description of the Related Art

Many applications require data transfer, and in some applications such as streaming video, the data transfer requires low latency. Servers, used for data transfer, data backup and streaming video, transfer data by reading the data from locally received packet streams, attached storage or from the storage attached over the network such as SAN (Storage Area Network) or NAS (Network Attached Storage) and send that data over the network after packaging it with the appropriate network protocols.

In today's interconnected world, more and more data is transmitted between locations for real-time or near real-lime applications. This increased bandwidth consumption is outstripping capacity and increasing the cost of providing large amounts of bandwidth. Common approaches to reduce the bandwidth usage are Caching and Compression. These techniques work well if the data is relatively static and compressible. The dominant factors for future network usage/bandwidth consumption, however, are from incompressible data such as Video, Audio, Pictures and pre-Compressed data. As Video and Multimedia data is increasing, traditional compression mechanisms are not effective when the flows have been pre-compressed, such as in MPEG video or JPEG pictures. Since such network traffic are already processed and compressed, they are generally not further compressible when considered as a single packet flow. Further, most of the data transferred going forward is typically not static, but dynamic, which requires retransmission over and over again.

### SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, the present invention provides for compressing data of a given input packet flow, the given input packet flow one of a plurality of packet flows. A flow parser associates each of the plurality of packet flows into one or more corresponding group types. For each packet flow and group type, corresponding context data is generated based on a windowed portion of the packet flow and a context memory is employed to store each context data for the corresponding ones of the plurality of packet flows. A signature generator generates a signature corresponding to each context data, each signature having a set of elements. A best match module matches, for the given input packet flow associated with a certain group type, the signature of the given input packet flow based on a best-match subset of elements with a signature of at least one previous packet flow of the certain group type. A compression core module encodes and compresses the given input packet flow based on selected context data corresponding to the best-match subset of elements.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows an exemplary data stream processing system employing one or more exemplary embodiments of the present invention for compression;

FIG. 2 shows an exemplary sequence of signatures for packet flows including corresponding sets of elements for the system of FIG. 1; and

FIG. 3 shows an exemplary method as might be employed by data stream processing system of FIG. 1.

### DETAILED DESCRIPTION

In accordance with exemplary embodiments of the present invention, processing of multiple data streams, generally as packet streams or flows, associated with, for example, streaming data is provided by improved methods of flow compression across multiple packet flows. As employed herein, “packet flow” refers to sequences of packets for a data stream, but might also comprise other types of streaming data including stream control and user data together. For a plurality of packet flows, the flows are first parsed into groups according to type, where each group type might exhibit similar characteristics or data patterns or strings. Context data is maintained for each flow based on a window, and a signature is generated for data of each windowed flow. The signature might comprise several portions corresponding to chunks of the data of the windowed flow, each portion generated as, for example, a hash. For a given input packet flow, its signature is compared against other flow signatures and existing context signatures and then a best match is determined. Given the context information for the best match, the present input flow can then be compressed. Processing for the data transformation examines currently arriving data and then processes the data based on the context data and previously known context information for other data streams from history stored in memory.

Compression is applicable where pattern repetitions occur or if information is otherwise redundant. Normal, single stream packet flows can be easily compressed to gain bandwidth savings if a large portion of the data is text, but traditional techniques are ineffective when the flow is already pre-compressed data, such as with MPEG encoded video data. Embodiments of the present invention reduce data flows more significantly than tradition data compression, by removing repeating patterns across the data flows, instead of within individual flows. Embodiments of the present invention reduce data flows of already compressed data further, by removing repeating patterns across the data flows, instead of within individual flows. To illustrate the point, a simple example would be to consider two flows that are transferring the same compressed MPEG video data at the same time. Each flow individually might not be compressed further, but if both flows are considered together, then one only flow might be transmitted and the second flow can be reconstructed at the other end. A more relevant example would be if two similar flows occurred one after another such as, first the finance news page from yahoo is transmitted and then subsequently the finance news page from Google® is transmitted—Individually compressing both would still require the compressed bandwidth of both, but using compression across flows the second flow of finance news from Google® could be compressed much more tightly as both similar share a lot of common data. Please note that the data need not be same, but sharing a lot of commonality like to the example of a form filled by multiple users.

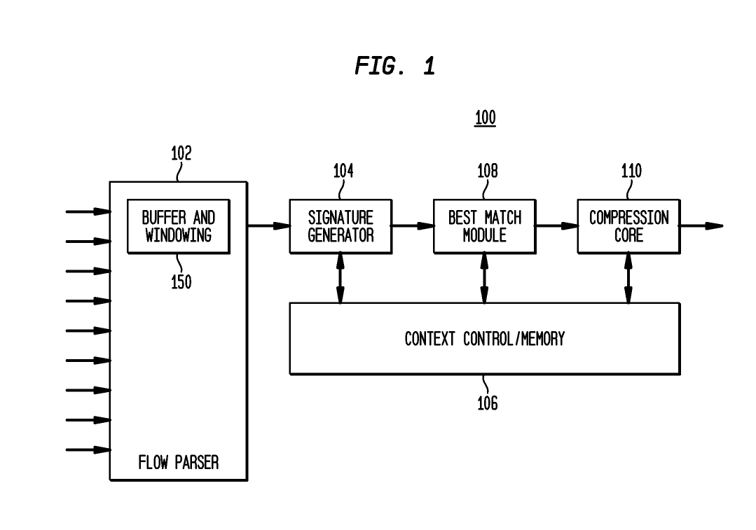

FIG. 1 shows an exemplary data stream processing system 100 employing one or more exemplary embodiments of the present invention for compression. Data stream processing system 100 comprises flow parser 102, signature generator 104, context control/memory 106, best match module 108, and compression core 110. Data stream processing system 100 receives a relatively large number of different and distinct packet flows, shown as one or more packet flows applied to flow parser 102.

Such packet flows to flow parser 102 might represent streaming video or audio data destined, differing web-pages, text data, computer data and the like to different users. For example, if stock of a Company A is in the news, different users might attempt to obtain information about Company A. One user might obtain the information from a Google® web-page, while the second user might obtain the information from a CNN® web-page. Both the Google web-page and the CNN® web-page might include an embedded video of an interview with Company A. Compression across several packet flows in accordance with embodiment of the present invention exploits the duplication of, for example, Company A's information in the two packet flows. When the first user obtains the web-page, data stream processing system 100 generates context information to compress the stream. This context information might be employed to also subsequently compress the second user's stream, even if the information of Company A is in the form of a compressed MPEG video stream embedded in the web-page. Since the two web-page videos are identical Company A information, only one needs to be sent to a receiver and the second reconstructed by a receiver from the first sent video. However, for described embodiments, in addition to finding identical data, flow compression herein goes further, so that two different forms for the same user or multiple users of the same form are compressed, so compression ratio is improved.

Flow parser 102, receives a relatively large number of different and distinct packet flows, and applies a form of packet fitter to the packet flows. The rules for the filter define types for groups of similar packet flows. For example, a video data stream might correspond to one type of grouping, web-pages of financial information sources might correspond to another type, audio files might correspond to yet another type, and so on. The present invention is not limited to these types and one skilled in the art might readily extend the teachings herein to define rules for other types during an initial classification stage. Further, the classification to a type for the packet flow data streams might employ information contained in the packet header or other control fields. Flow parser 102 might be implemented as an FPGA solution for some embodiments.

As shown in FIG. 1, flow parser 102 includes buffer 150 to receive each packet flow. A windowing function might be applied to the packet flows passing through flow parser 102. For each packet flow, the windowed portion of the packet flow corresponds to stored context data for processing of the windowed portion by compression core 110, described subsequently.

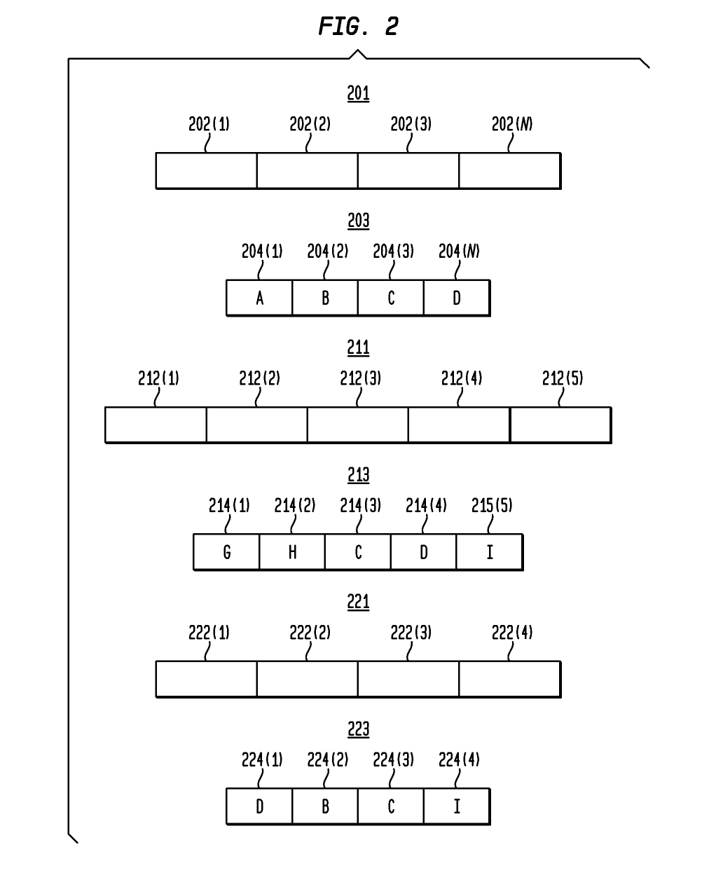

Signature generator 104 generates a signature corresponding to each windowed portion of a packet flow. To generate the signature, the data of the windowed portion is divided into chunks and a hash function applied to each chunk. The resulting hash values of the chunks represent elements of the signature. FIG. 2 shows an exemplary sequence of signatures for packet flows including corresponding sets of elements for the system of FIG. 1. For example, Packet Flow 1 has windowed portion 201, divided into chunks 202(1) through 202(N), N a positive integer, where window portions might have a typical exemplary length of between 250 Bytes and 1 MByte. The longer the length of windowed portion 201, the greater the context data (including context history) and better compression. Each of chunks 202(1) through 202(N) has a hash function applied, yielding signature 203 of elements 204(1) through 204(N). Signature 203 of a packet flow is considerably shorter in length than the corresponding windowed portion 201, and might be stored in context generator/memory 106. Signature generator 104 might be implemented as an FPGA solution for some embodiments.

Returning to FIG. 1, context control/memory 106, which might be implemented as a DDR (double data rate) memory with associated logic, Context data is generated during compression by compression core 110 as described below, and is maintained for each packet flow. For some embodiments, the context data might occupy 32 kBytes. In addition, context control/memory 106 might also store the associated signature, although other embodiments might advantageously store the context data and associated signature separately to increase processing and/or data access speed.

Best match module 108 receives the signature for the currently processed input packet flow, and determines a “best match” signature of previous packet flows that might be employed to access context data of other flows or other compression techniques information that might be used in performing compression by compression core 110. To search for such best match, the process searches through signatures of the same group type, and attempts to locate a signature that contains, for example, a greatest number of elements (e.g., hash values) in common, although a best match might also be determined by other criteria, such as greatest number of in common elements that are contiguous, or largest number of elements that provide the greatest individual compression, and so forth.

For example, returning to FIG. 2, signature 203 of elements 204(1) through 204(N) provides a sequence of hash values A, B, C, and D, respectively (N is 4). Signature 213 for portion 211 of elements 214(1) through 214(5) provides a sequence of hash values G, H, C, D, and I, respectively. Signature 223 for portion 221 of elements 224(1) through 224(3) provides a sequence of hash values D, B, C, and I, respectively. Since signature 223 has three elements in common with signature 203, although in different order, context data associated with the packet flow of signature 223 might be employed for compression (by compression core 110) of the current input packet flow.

Compression core 110 is configured to apply any of number of known types of data compression to the packet flow's data stream via, for example, a corresponding compression engine based on LZ or GZIP algorithms. Compression core 110 might also employ several different types of compression techniques, including stateful compression such as context switching. Compression core 202 is coupled to context control/memory 106.

Many operating systems implement concurrency by maintaining separate environments or “contexts” for each process. The amount of separation between processes, and the amount of information in a context, depends on the operating system, but generally higher level coordination is employed to prevent processes from interfering with each other (e.g., by modifying each other's memory data, or pages). Context switching refers to when a multi-tasking operating stops running one process and starts running another. A context switch might simply change values of program counter(s) and stack pointer(s), or might reset the entire processor unit to make a different set of memory pages available. Many systems context switch at an exceptionally high rate in order to present the user with an impression of parallel processing, and to allow processes to respond quickly to external events.

During compression applied by compression core 110, a history of previous data and tables for looking up into this history is generated, and then stored in memory. This data forms the context data for the compressor, and, as the history entries increase, context processing improves, thereby improving compression. In certain applications, the input data for a given data stream does not always arrive at once, but rather are broken up into packets. Also, packets of different data streams are mixed together when they reach compression core 110. So, when a packet of a particular data stream is compressed, the corresponding context data is saved, along with possibly past context data information/history as aggregated context data, and this saved, aggregated context data is subsequently employed for the compression of the next arriving packet of the particular data stream, When the saved context data is used to process the subsequently arriving packet of the particular stream, the corresponding previous history data is used, The compression engine might be optimized for using this previous history since knowledge of compression of the previous packet might enable the compression engine to avoid repeating analysis, state transition, and/or processing steps during the compression process for the packet. Thus, use of the context history provides better compression than if the packets are individually compressed.

For an exemplary embodiment of the present invention, transformation data and history of context data might generated at the transmit side, but during the decoding process the same context information is generated, and transmit and receive sides might also share information related to context data through separate communication channels. This transformation data and history of context data might be continuously updated, providing better compression performance as more packet flows are processed. In addition, transformation data and history of context data might be modified based on traffic statistics. For example, during work hours, most packet flows might be associated with web-access, or database applications. In contrast, packet flows during off-work hours might be storage back-up. Context data might be modified based on this knowledge. Also, various parameters might be modified based on the traffic statistics. Window size, level of confidence in best match processing, length of search and the like might also be modified based on traffic characteristics.

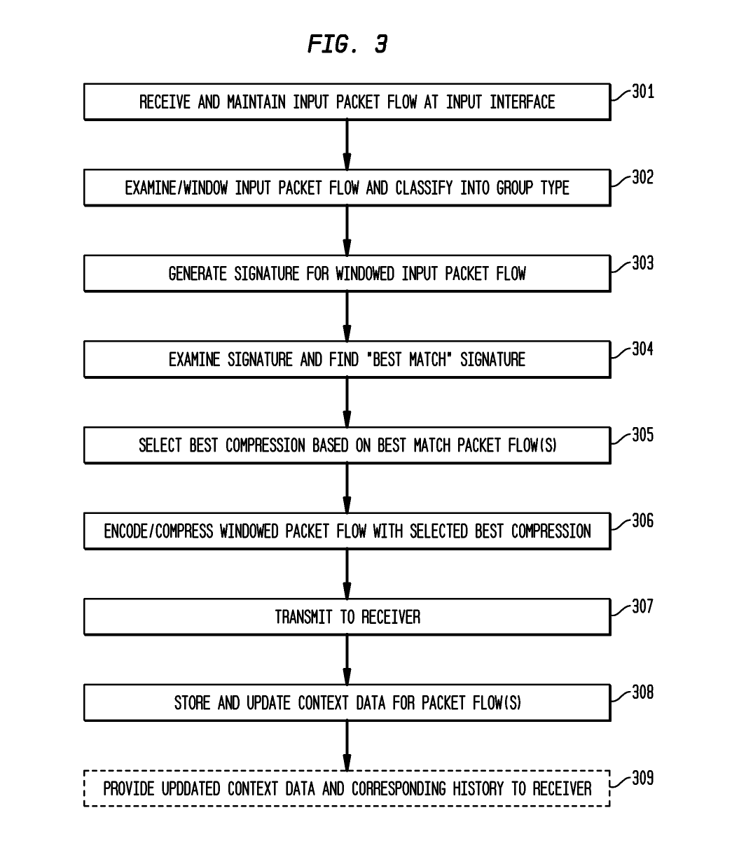

FIG. 3 shows an exemplary method 300 as might be employed by data stream processing system 200 of FIG. 1. At step 301, one or more packets of streaming data for an input flow are received by an input interface which maintains the stream though a hand-shake process at its IO interface and a windowing is applied to the input flow. At step 302, the input flow is examined, for example by packet filtering, and is also parsed into a group type. At step 303, a signature is generated for the windowed input flow. At step 304, the signature is examined and a best match found across packet flows present in the system. Based on the best match, at step 305, a best method of compression based on previous context data corresponding to the packet flow for the elements of the best match is selected. At step 306, encoding and compression are applied to the windowed packet flow, such as an LZ or GZIP algorithm, and an encoded/compressed packet flow is provided. At step 307, the compressed, windowed packet flow is transmitted to a receiver, which applies an inverse decoding/de-compression process to provide the packet flow to a user. At step 308, context data for the present input packet flow is stored, and context data history information is updated. Optionally, at step 309, the context data information of the receiver might also be updated based upon action of the transmitting system.

The embodiments described above allow for real-time or near real-time compression of data flows. The preferred embodiments present a tradeoff between compression and latency introduced by the compression process. Other applications might not require real-time or near real-time compression, and so might allow for other compression techniques to increase compression and reduce bandwidth consumption. For example, in situations where hard disks or other storage media are backed-up, redundant or otherwise duplicated information might be identified and original size reduced much more significantly using cross flow compression rather than normal compression. Such de-duplication process (or, “cross flow compression”) is a compression with relatively large windows and a large external shared dictionary. Both the dictionary and the compression windows are typically in the order of gigabytes. Such cross flow compression process might occur as follows.

The cross flow compression process searches for duplicate strings in a base data set and replaces occurrences of such duplicates with a reference back to the original string. For example, several legal documents stored in a file might be similar, with only names and addresses differing between documents. A “normal” approach would be to compress the document, providing compression, but when the same form is filled by multiple users both the form text and data are compressed and stored. Flow compression stores only one copy of the document portions except those that change, as well as the changed information. However, unlike traditional compression, the strings are actually extracted from the data set and put into a large shared dictionary. Thus, cross flow compression even achieves compression efficiency across disparate files and network streams.

The efficiency of the cross flow compression process depends on the ability to find data recurrences. Analysis of wide range of existing data shows that data shifts impede matches. Detecting recurrence boundaries through a sliding window followed by chuck matches reduces the impact of data shifts. The sliding window matches are done using a sophisticated weak sum that has high probability of avoiding false positives and has no Use negatives. After a detection of a boundary, subsequent data following the boundary detection are matched as chucks that improve performance at reduced cost. A configurable chunk size and a heuristic mechanism is used to contain the memory bandwidth explosion that occurs with use of a sliding window. The chunk size can be configured to balance the storage, resource size and de-duplication success rate. Duplicate chunks are discarded and only the reference to the original is stored after incrementing the reference count. Unduplicated data is split into fixed size chunks and stored for future cross flow compression.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing blocks in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

Unless explicitly stated otherwise, each numerical value and range should be interpreted as being approximate as if the word “about” or “approximately” preceded the value of the value or range.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

No claim element herein is to be construed under the provisions of 35 §112, sixth paragraph, unless the element is expressly recited using the phrase “means for” or “step for.”

It will be further understood that various changes in the details, materials, and arrangements of the parts which have been described and illustrated in order to explain the nature of this invention may be made by those skilled in the art without departing from the scope of the invention as expressed in the following claims.

We claim:

1. A method of compressing data of a given input packet flow, the given input packet flow one of a plurality of packet flows, the method comprising the steps of:
associating, by a flow parser, each of the plurality of packet flows into one or more corresponding group types;
generating, for each packet flow and group type, corresponding context data based on a windowed portion of the packet flow and storing, in a context memory, each context data for the corresponding ones of the plurality of packet flows;
generating, by a signature generator, a signature corresponding to each context data, each signature having a set of elements;
matching, for the given input packet flow associated with a certain group type, the signature of the given input packet flow based on a best-match subset of elements with a signature of at least one previous packet flow of the certain group type; and
encoding and compressing, by a compression core module, the given input packet flow based on selected context data corresponding to the best-match subset of elements.

2. The method of claim 1, further comprising updating the context data for selected corresponding ones of the plurality of packet flows based on the compressing.

3. The method of claim 2, further comprising transferring the compressed data to a receiver, wherein the receiver comprises a mirror image of the context data, and decoding, based on the mirror image of the context data, the encoded and compressed given input packet flow.

4. The method of claim 1, wherein for the generating the signature corresponding to each context data, each signature having a set of elements, comprises generating one or more hash values as the set of elements for the context data corresponding to the a set of elements based on a windowed portion of the packet flow.

5. The method of claim 1, wherein the encoding and compressing employs at least one of a cache table, compression engine, context switching, and cross flow compression.

6. The method of claim 5, wherein the compression core module employs at least one of a LZ method and a GZ1P method.

7. The method of claim 1, wherein the context data for each packet flow comprises current context data and context history data.

8. The method of claim 1, further comprising updating the context data for selected corresponding ones of the plurality of packet flows based on traffic statistics.

9. An apparatus for compressing data of a given input packet flow, the given input packet flow one of a plurality of packet flows, the apparatus comprising:
a flow parser configured to associate each of the plurality of packet flows into one or more corresponding group types;
a context memory configured to store, for each packet flow and group type, i) corresponding context data based on a windowed portion of the packet flow and ii) each context data for corresponding ones of the plurality of packet flows;
a signature generator configured to generate a signature corresponding to each context data, each signature having a set of elements;
a best match module configured to match, for the given input packet flow associated with a certain group type, the signature of the given input packet flow based on a best-match subset of elements with a signature of at least one previous packet flow of the certain group type; and
a compression core module configured to encode and compress the given input packet flow based on selected context data corresponding to the best-match subset of elements.

10. The apparatus of claim 9, wherein the compression core module is further configured to update the context data for selected corresponding ones of the plurality of packet flows based on the compressing.

11. The apparatus of claim 10, further comprising a transmitter configured to transfer the compressed data to a receiver, wherein the receiver comprises a mirror image of the context data, and decodes, based on the mirror image of the context data, the encoded and compressed given input packet flow.

12. The apparatus of claim 9, wherein the signature module generates the signature corresponding to each context data, each signature having a set of elements as one or more hash values for the context data corresponding a windowed portion of the packet flow.

13. The apparatus of claim 9, wherein the compression core module employs at least one of a cache table, compression engine, context switching, and cross flow compression.

14. The apparatus of claim 13, wherein the compression core module employs at least one of a LZ method and a GZIP method.

15. The apparatus of claim 9, wherein the context data for each packet flow comprises current context data and context history data.

16. The apparatus of claim 9, wherein the compression core module is further configured to update the context data for selected corresponding ones of the plurality of packet flows based on traffic statistics.

17. A non-transitory machine-readable storage medium, having encoded thereon program code, wherein, when the program code is executed by a machine, the machine implements a method for compressing data of a given input packet flow, the given input packet flow one of a plurality of packet flows, comprising the steps of:
associating, by a flow parser, each of the plurality of packet flows into one or more corresponding group types;
generating, for each packet flow and group type, i) corresponding context data based on a windowed portion of the packet flow and storing, in a context memory, each context data for the corresponding one of the plurality of packet flows;
generating, by a signature generator, a signature corresponding to each context data, each signature having a set of elements;
matching, for a given input packet flow associated with a certain type, the signature of the given input packet flow based on a best-match subset of elements with a signature of at least one previous packet flow of the certain type; and
encoding and compressing, by a compression module, the given input packet flow based on selected context data corresponding to the best-match subset of elements.
